(19) United States
(12) Patent Application Publication
(10) Pub. No.: US 2008/0313307 A1
(43) Pub. Date: Dec. 18, 2008

(54) URL-BASED KEYWORD ADVERTISING

(75) Inventor: Tantek Celik, Stanford, CA (US)

Correspondence Address: BEYER WEAVER LLP, P.O. BOX 70250, OAKLAND, CA, 94612-0250, US

(73) Assignee: TECHNORATI, INC., San Francisco, CA (US)

(21) Appl. No.: 11/774,461

(22) Filed: Jul. 6, 2007

Related U.S. Application Data
(60) Provisional application No. 60/943,382, filed on Jun. 12, 2007.

(51) Int. Cl. G06F 15/16

(52) U.S. Cl. 709/218

(57) ABSTRACT

Methods and apparatus are described for presenting advertising content on a user device in conjunction with requested content. The advertising content is selected with reference to advertising targeting information. The advertising targeting information is generated by processing the URL associated with the request for the requested content generated by the user device.

### BACKGROUND OF THE INVENTION

The present invention relates to techniques for serving advertisements over the Internet.

### SUMMARY OF THE INVENTION

According to the present invention, methods and apparatus are provided for presenting advertising content on a user device in conjunction with requested content. The advertising content is selected with reference to advertising targeting information. The advertising targeting information is generated by processing the uniform resource locator (URL) associated with the request for the requested content generated by the user device.

According to a specific embodiment, a request is received for content having a URL associated therewith. The URL is processed to generate advertising targeting information. Advertising content is identified with reference to the advertising targeting information. The advertising content is then presented over the network in conjunction with the requested content.

A further understanding of the nature and advantages of the present invention may be realized by reference to the remaining portions of the specification and the drawings.

### BRIEF DESCRIPTION OF THE DRAWINGS

FIG. 1 is a network diagram illustrating an exemplary environment in which embodiments of the invention may be implemented.

FIG. 2 is a flowchart illustrating a specific embodiment of the invention.

FIG. 3 is another flowchart illustrating another specific embodiment of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

The present invention provides techniques for targeting advertisements on the Internet. According to specific embodiments, the specific ads presented in a user's Web browser are determined with reference to a Uniform Resource Locator (URL) to which the browser is directed. Some exemplary embodiments are described below.

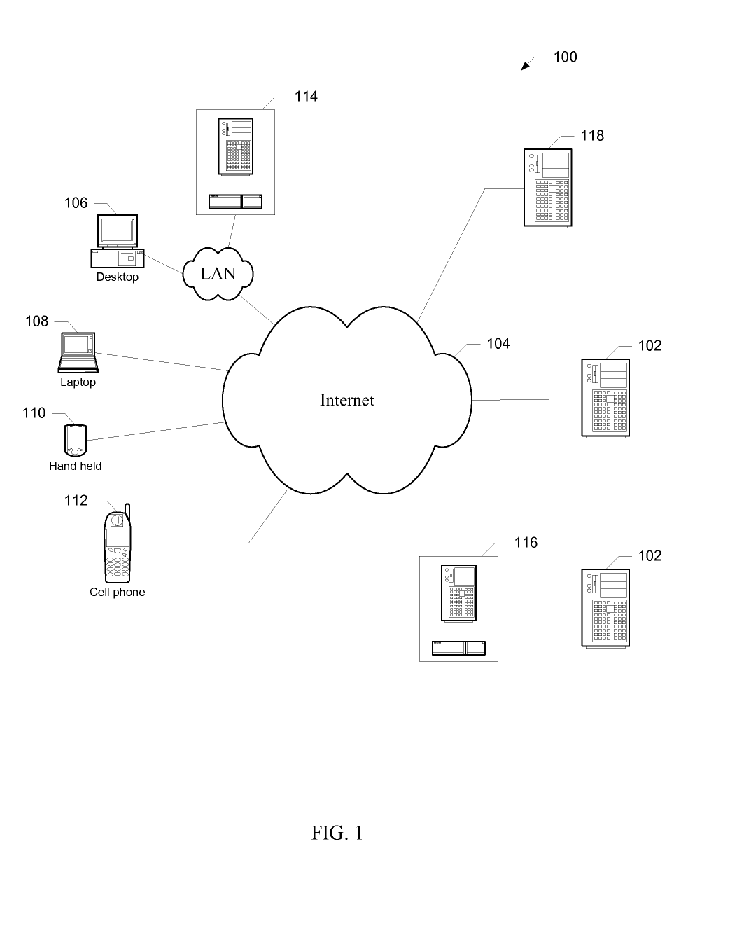

FIG. 1 is a diagram of an exemplary network environment in which embodiments of the present invention may be implemented. Examples of such embodiments in the context of the World Wide Web are described below. It will be understood, however, that the present invention may be practiced in a wide variety of network environments and should not be limited by such references.

FIG. 1 illustrates a wide area network 100 in which users may access Web sites (represented by servers 102) via the Internet 104 using any of a wide variety of devices, e.g., desktop 106, laptop 108, handheld device, 110, cell phone 112, etc. When a user requests content, e.g., a Web page, from server 102 (e.g., using a browser application), the requested content is returned to the user's device from server 102 or some intermediate cache (e.g., 114 and 116).

In addition to the requested content, advertisements are also typically presented on the user's device using a variety of mechanisms, e.g., embedded in the returned page, pop-up windows, or drop-down animations. The nature of the returned advertising content may be determined with reference to a wide variety of parameters including, for example, the nature of the requested content, keywords identified by the user in a search interface, the identity and/or demographics of the user, etc. The advertising content may then be returned from the same site as the requested content or, alternatively, from an associated or third party site 118. It will be understood that the distributed nature of the computing environments in which the present invention may be practiced makes it possible for the various steps of the claimed technique, e.g., determining and serving the ad content, to be performed by one computing platform or multiple platforms operating together. The invention should therefore not be limited to a specific network configuration or computing technique.

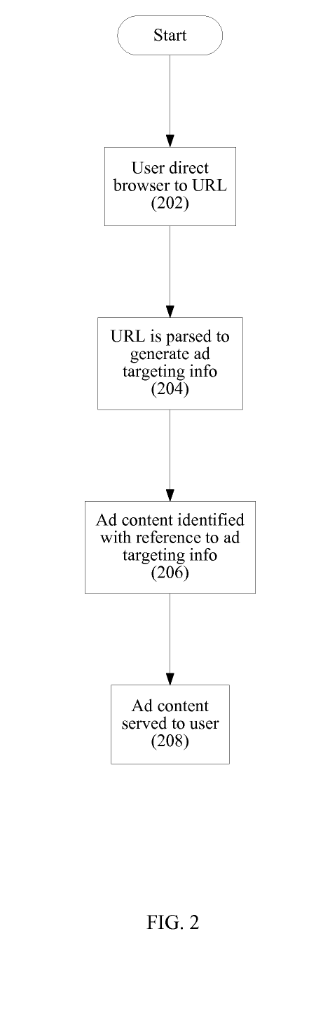

According to a specific embodiment of the invention, the nature of the advertising content to be presented in conjunction with the requested content is determined with reference to the URL to which the original content request was directed. Specific embodiments of the invention will now be described with reference to the flowchart of FIG. 2. When a user directs his browser to a specific URL (202), e.g., by entering the URL or selecting a link corresponding to the URL, the URL (i.e., as opposed to the requested page itself) is parsed to generate ad targeting information, e.g., one or more relevant keywords, date information, day of the week as derived from the date, month, season, holiday based on a holiday database lookup, year, anniversaries, birthdays, and other yearly events (204). Specific advertising content is identified with reference to the ad targeting info (206), and then served to the user for presentation on the user's device (208).

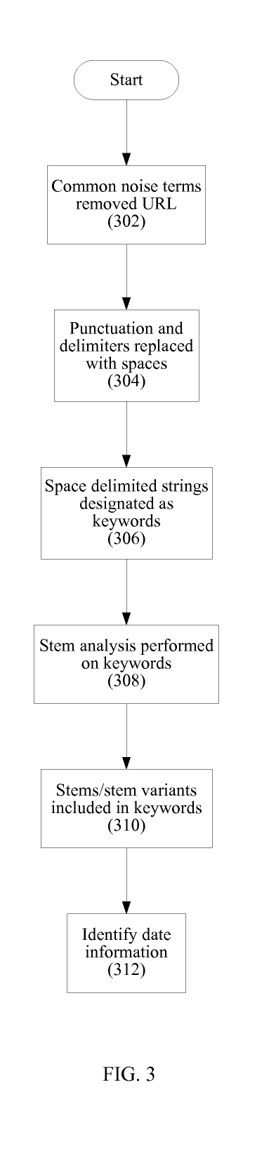

According to various embodiments of the invention, the manner in which the URL is parsed to generate the ad targeting info may vary. According to a specific embodiment illustrated in FIG. 3, the URL is parsed to generate one or more keywords. It should be noted that embodiments are contemplated in which at least some of the steps described are not included and in which the steps are performed in different orders. In the embodiment shown, common noise terms (e.g., http://, ftp:// .com, .net, .org, any of a plurality of URL protocol schemes, and/or other top level domains) are removed from the URL (302). Punctuation and other delimiters (e.g., /, _, -) are replaced with spaces (304). The resultant space delimited strings are designated as keywords (306). Stem analysis may then be performed on these keywords to identify stem words and stem variants (308) which may be included in the list of keywords (310).

According to various embodiments, a variety of techniques for determining ad content from keywords, including those well known in the industry, may be employed. For example, the keywords may be employed to perform a straightforward keyword ad lookup. According to one embodiment, ad content may be determined, at least in part, with reference to the frequency of particular keywords in the post-processed URL. That is, for example, the keyword order used in an ad lookup can be determined by the frequency of keywords in the list.

Referring once again to FIG. 3, the URL may also be parsed to generate date information (312). This may be accomplished by searching for common date formats in the URL, e.g., YYYYMMDD, /YYYY/MM/DD, YYYY_MM_DD (with optional leading zeros for the month and day). Ad content could then be determined based on any kind of information derivable from such date information. For example, in addition to any components of the actual date, e.g., month or year, any of the following may be determined: the day of the week (i.e., Sunday-Saturday), the season (e.g., winter-fall, specific holiday seasons, etc.), anniversaries or birthdays (e.g., with reference to publicly available information or private user specific data), events on that date, etc. Any of this information may be used to select specific advertising content for presentation to the user.

Thus, for example, for the URL “http://photomatt.net/2003/12/15/distributed-social-networking-software,” the keywords photomatt, distributed, social, networking, and software might be generated along with identification of the date Dec. 15, 2003.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for presenting advertising content over a network in conjunction with requested content, the method comprising:
receiving a request for content having a uniform resource locator (URL) associated therewith;
processing the URL to generate advertising targeting information;
identifying advertising content with reference to the advertising targeting information; and
presenting the advertising content over the network in conjunction with the requested content.

2. The method of claim 1 wherein the request for content comprises a request for a Web page generated by a browser.

3. The method of claim 1 wherein the advertising targeting information comprises at least one keyword derived from the URL.

4. The method of claim 3 wherein the at least one keyword comprises a plurality of keywords, the method further comprising ordering the keywords by frequency.

5. The method of claim 3 wherein identifying the advertising content comprises performing an advertising lookup using the at least one keyword.

6. The method of claim 3 wherein processing the URL to generate advertising targeting information comprises removing at least one noise string from the URL.

7. The method of claim 6 wherein the at least one noise string comprises one or more of http://, ftp://, .com, .net, .org, any of a plurality of URL protocol schemes, or any of a plurality of top level domain identifiers.

8. The method of claim 6 further comprising replacing punctuation and delimiters replaced with spaces.

9. The method of claim 3 further comprising performing stem analysis on the at least one keyword to generate at least one other keyword.

10. The method of claim 1 wherein the advertising targeting information comprises a date.

11. The method of claim 10 wherein identifying the advertising content comprises determining additional information relating to the date.

12. The method of claim 11 wherein the additional information comprises one or more of month, year, day of the month, day of the week, season, event, week of the year, or day of the year.

13. The method of claim 1 wherein presenting the advertising content in conjunction with the requested content comprises one or more of embedding the advertising content in a requested Web page, presenting a pop-up window including the advertising content in association with a requested Web page, or placing the advertising content in a drop-down animation.

14. The method of claim 13 wherein the advertising content is served from a different server than the requested content.

15. The method of claim 13 wherein the advertising content is served from the same server as the requested content.

16. A computer-implemented method comprising presenting advertising content on a user device in conjunction with requested content, the advertising content having been selected with reference to advertising targeting information, the advertising targeting information having been generated by processing of a uniform resource locator (URL) associated with a request for the requested content generated by the user device.
